(19) United States
(12) Patent Application Publication
(10) Pub. No.: US 2014/0121856 A1
(43) Pub. Date: May 1, 2014

(54) METHOD AND SYSTEM FOR MEASURING TILT ANGLE OF VEHICLE

(71) Applicants: HYUNDAI MOTOR COMPANY, Seoul (KR); KIA MOTORS CORPORATION, Seoul (KR)

(72) Inventor: Jinkuk Cho, Goyang (KR)

(73) Assignees: Kia Motors Corporation, Seoul (KR); Hyundai Motor Company, Seoul (KR)

(21) Appl. No.: 13/717,311

(22) Filed: Dec. 17, 2012

(30) Foreign Application Priority Data
Oct. 26, 2012 (KR) 10-2012-0119995

(51) Int. Cl. G06F 17/00

(52) U.S. Cl. CPC G06F 17/00
USPC 701/1

(57) ABSTRACT

Disclosed herein is a method and system for measuring a tilt angle including detecting acceleration of a vehicle through an acceleration sensor; detecting a vehicle speed through a vehicle speed sensor; detecting a position of a shift lever through a shift lever position detector; detecting, by a controller, a rotation direction of a wheel; detecting, by the controller, a rotation direction of a motor; receiving, by the controller, a plurality of input signals; inverting, by the controller, a value of the vehicle speed to a negative number based on the detected position of the shift lever, the rotation direction of the wheel, and the rotation direction of the motor; calculating, by the controller, traveling acceleration based on the vehicle speed or the inverted vehicle speed; and calculating, by the controller tilt angle of the road based on the traveling acceleration and the sensor acceleration.

### CROSS-REFERENCE TO RELATED APPLICATION

This application claims priority to and the benefit of Korean Patent Application No. 10-2012-0119995 filed in the Korean Intellectual Property Office on Oct. 26, 2012, the entire contents of which are incorporated herein by reference.

### BACKGROUND OF THE INVENTION

(a) Field of the Invention

The present invention relates to a method and system for measuring a tilt angle, and more particularly to a method and system for maintaining continuity of a tilt angle measurement of a traveling road by measuring a tilt angle of the traveling road by inverting a vehicle speed value when a vehicle reverses in a reverse gear (R) or when a vehicle slips backward in a drive gear (D) or a neutral gear (N).

(b) Description of the Related Art

In general, a vehicle travels on an inclined traveling road at a tilted angle and the tilt angle may be used for various purposes. For example, to improve fuel consumption and determine a change in a speed pattern of the vehicle, a tilt angle of a road may be used. Further, a tilt angle may be used to prevent the vehicle from slipping backward upon starting. Furthermore, the tilt angle may be used for determination of a traveling path of a navigation device, a position control of the vehicle, fuel consumption improvement of the vehicle, and detection of real time energy consumption of the vehicle.

The tilt angle may be measured by various methods such as use of an atmospheric pressure sensor, an acceleration sensor, an electronic compass, or a gyro sensor, but an acceleration sensor is widely used.

Most acceleration sensors are a longitudinal acceleration sensor that measures longitudinal acceleration. The longitudinal acceleration sensor generally uses a piezoelectric sensor. The longitudinal acceleration sensor using a piezoelectric sensor has a long bar form, and when the piezoelectric sensor of the long bar form is bent by an acceleration force, the piezoelectric sensor outputs a voltage corresponding thereto. The voltage represents corresponding acceleration.

An example of calculating a tilt angle using the acceleration sensor will be described with reference to FIG. 1.

An output signal value (long_accel_val) of the acceleration sensor and a tilt angle (θ) corresponding to the output signal value may be calculated by the following Equation 1.

$$Ma = F - ( {F}_{areodynamic} + {F}_{Rolling} + {F}_{Climbing} )$$

$$Ma = F - ( {F}_{areodynamic} + {F}_{Rolling} + Mg sin θ )$$

$$F - ( {F}_{areodynamic} + {F}_{Rolling} ) = M \cdot ( a + g sin θ )$$

$$long\_accel \_val = a + g sin θ$$

$$g sin θ = long\_accel \_val - a$$

$$sin θ ≅ θ = \frac{1}{g} ( long\_accel \_val - a ) \\ ∴ θ = \frac{1}{g} ( long\_accel \_val - a )$$

Wherein, M is a vehicle mass; a is a traveling acceleration of a vehicle; g is a gravity acceleration; F is an output of the vehicle; F_{aerodynamm} is air resistance of the vehicle; F_{rolling} is rolling resistance of the vehicle; and F_{climbing} is tilt resistance of the vehicle.

For example, a traveling acceleration (a) of the vehicle may be obtained by differentiating an output value of a vehicle speed sensor that detects a vehicle speed. To obtain traveling acceleration of the vehicle by differentiating an output value of the vehicle speed sensor is well known to a person of a common skill in the art and therefore a detailed description thereof will be omitted.

When an output value (long_accel_val) and the traveling acceleration (a) of the vehicle speed sensor are known, a tilt angle (θ) is calculated by Equation 1 above. In Equation 1, when there is no difference between the output value (long_accel_val) of the acceleration sensor and the traveling acceleration (a), it may be determined that the tilt angle is 0 and the road is substantially level.

As described above, a conventional method that measures a tilt angle using the acceleration sensor calculates a road tilt angle with a difference between an output value of an acceleration sensor and the traveling acceleration that is calculated from a vehicle speed. However, in a conventional method, a vehicle speed may be determined by a value in which a brake controller coverts a wheel rotation speed of the vehicle to a vehicle speed. Further, the vehicle speed value obtained from the brake controller only outputs a positive value regardless of the vehicle moving forward or backward. In other words, through this method of obtaining the current vehicle speed, it may not be determined whether the vehicle is moving forward or backward.

Thereby, in a conventional method of measuring a tilt angle, because a tilt angle is measured without distinguishing when the vehicle moves forward or backward, continuity of tilt angle measurement may not be obtained.

For example, when a vehicle travels up an inclined road, an acceleration sensor value outputs an acceleration sensor value corresponding to a tilt angle of the inclined road. However, when a vehicle reverses while slipping backward on the inclined road, or when a vehicle reverses in a reverse gear (R), an acceleration sensor value reduces by a value that accelerates by reversing from an acceleration sensor value by an actual tilt angle. Therefore, when measuring a tilt angle with a difference between a reduced acceleration sensor value and a traveling acceleration value using a vehicle speed value of a brake controller that outputs only a positive value, the measured tilt angle is oscillated, as shown in FIG. 2 and thus continuity of the measured tilt angle may not be obtained. Additionally during this process, a controlling device of a vehicle using a tilt angle may perform a wrong control due to the lack of continuity in the measuring of the tilt angle.

FIG. 2 is a graph illustrating a process with a hybrid vehicle using combined power of an internal combustion engine and a motor. Referring to FIG. 2, as the vehicle slips backward, in an area in which a measured tilt angle oscillates, it may be seen that a revolutions per minute (RPM) of a motor of the hybrid vehicle changes to a negative (−) value, (e.g., a rotating direction changes) and a vehicle speed of a brake controller is continuously output to a positive (+) value.

The above information disclosed in this Background section is only for enhancement of understanding of the background of the invention and therefore it may contain information that does not form the prior art that is already known in this country to a person of ordinary skill in the art.

### SUMMARY

The present invention has been made in an effort to provide a method and system for measuring a tilt angle having advantages of maintaining continuity of a tilt angle measurement of a traveling road by a measuring a tilt angle of the traveling road by inverting a vehicle speed value when a vehicle reverses in a reverse gear (R) or when a vehicle slips backward in a drive gear (D) or a neutral gear (N).

An exemplary embodiment of the present invention provides a method of measuring a tilt angle of a traveling road, the method including: detecting acceleration of a vehicle through an acceleration sensor; detecting a vehicle speed through a vehicle speed sensor; detecting a position of a shift lever through a shift lever position detector; detecting a rotation direction of a wheel; detecting a rotation direction of a motor;

inverting a value of the detected vehicle speed to a negative number based on the detected position of the shift lever, the rotation direction of the wheel, and the rotation direction of the motor; calculating traveling acceleration based on the detected vehicle speed or a vehicle speed that is inverted to the negative number; and calculating a tilt angle of the traveling road based on the calculated traveling acceleration and the sensor acceleration.

The inverting of a value may include inverting, when the detected position of the shift lever is a reverse position R, a value of the detected vehicle speed to the negative number. The inverting of a value may include inverting, when the detected position of the shift lever is a driving position D or a neutral position N and when a wheel of the vehicle rotates in a direction opposite to an advancing direction, a value of the detected vehicle speed to the negative number.

When the vehicle is an electric vehicle traveling with power of a motor, the inverting of a value may include inverting, when the detected position of the shift lever is a driving position D or a neutral position N and when the motor rotates backward, a value of the detected vehicle speed to the negative number.

Another embodiment of the present invention provides a system that measures a tilt angle of a traveling road, the system including: a vehicle speed sensor that detects a vehicle speed; an acceleration sensor that detects acceleration of a vehicle; a shift lever position detector that detects a shift lever position of the vehicle; and a tilt angle measurement device, controlled by a controller, that receives an input of a signal of the vehicle speed sensor, the acceleration sensor, and the shift lever position detector and that measures a tilt angle of the traveling road, wherein the tilt angle measurement device operates by a predetermined program including a series of commands for executing the method of measuring a tilt angle according to the foregoing exemplary embodiment of the present invention.

The tilt angle measuring device may include a plurality of units controlled by the controller. The plurality of units may include a vehicle speed input unit that receives an input of a signal of the vehicle speed sensor; an acceleration input unit that receives an input of a signal of the acceleration sensor; a shift lever position input unit that receives an input of a signal of a shift lever position detector; a wheel rotation direction detection unit that detects a rotation direction of a wheel of the vehicle; a motor rotation direction detection unit that detects a rotation direction of the motor; a vehicle reverse determination unit that determines when the vehicle reverses based on the position of the shift lever, the rotation direction of the wheel, and the rotation direction of the motor; a vehicle speed inversion unit that inverts a value of the detected vehicle speed to the negative number when the vehicle reverses; a traveling acceleration calculation unit that calculates traveling acceleration based on the detected vehicle speed or a vehicle speed that is inverted to the negative number; and a tilt angle calculation unit that calculates a tilt angle based on the calculated acceleration and acceleration that is detected by the acceleration sensor.

As described above, according to an exemplary embodiment of the present invention, when a vehicle reverses in a reverse gear (R) or when a vehicle slips backward in a drive gear (D) or a neutral gear (N), by a measuring a tilt angle of a traveling road by inverting a vehicle speed value, continuity of the tilt angle measurement may be maintained.

### BRIEF DESCRIPTION OF THE DRAWINGS

FIG. 1 is an exemplary diagram illustrating a conventional method of measuring a tilt angle, according to the related art.

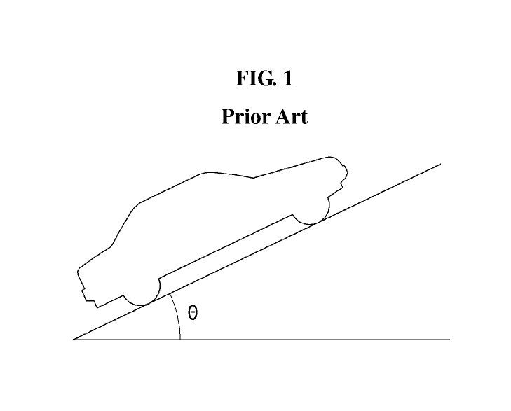

FIG. 2 is an exemplary diagram illustrating a problem of a conventional method of measuring a tilt angle, according to the related art.

FIG. 3 is an exemplary block diagram illustrating a configuration of a tilt angle measuring system, according to an exemplary embodiment of the present invention.

FIG. 4 is an exemplary flowchart illustrating a method of measuring a tilt angle, according to an exemplary embodiment of the present invention.

FIG. 5 is an exemplary tilt angle measuring graph, according to an exemplary embodiment of the present invention.

### DETAILED DESCRIPTION OF THE EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller refers to a hardware device that includes a memory and a processor. The memory is configured to store the modules/units and the processor is specifically configured to execute said modules to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM,

RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

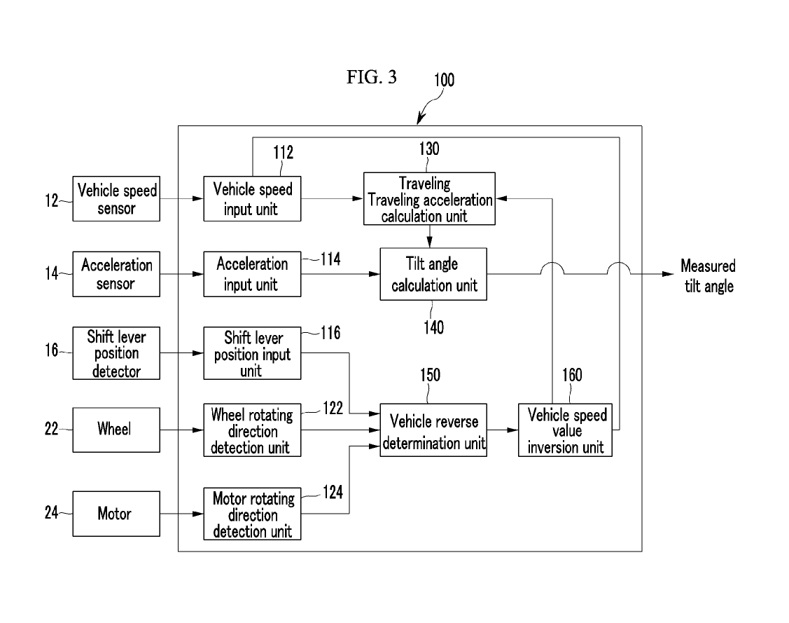

FIG. 3 is an exemplary block diagram illustrating a configuration of a tilt angle measuring system, according to an exemplary embodiment of the present invention.

The tilt angle measuring system according to an exemplary embodiment of the present invention is a tilt angle measuring system that continuously measures a tilt angle when a vehicle reverses or when a vehicle slips backward. The system may include a vehicle speed sensor 12 configured to detect a vehicle speed; an acceleration sensor 14 configured to detect an acceleration of the vehicle; a shift lever position detector 16 configured to detect a shift lever position of the vehicle; and a tilt angle measuring device 100, controlled by a controller, configured to receive an input of a signal of the vehicle speed sensor 12, the acceleration sensor 14, and the shift lever position detector 16 and to detect a rotating direction of a wheel 22 and a rotating direction of a motor 24 and that to measure the tilt angle of a traveling road based on the input signals.

The tilt angle measuring device 100 may operate by a predetermined program including a series of commands for performing a method of measuring a tilt angle according to an exemplary embodiment of the present invention.

The vehicle speed sensor 12 may be, for example, a sensor attached to the wheel 22 to detect a rotation speed of the wheel 22, but it should be understood that the present invention is not limited thereto. When the vehicle speed sensor 12 has a configuration that may output a signal corresponding to a vehicle speed, the vehicle speed sensor 12 may be within the scope of the present invention.

The acceleration sensor 14 may be a sensor that is conventionally applied to the vehicle to detect acceleration of the vehicle. The shift lever position detector 16 may be a detector or a sensor that is conventionally applied to the vehicle to detect a shift lever position of the vehicle and may be formed as, for example, an inhibitor switch, but it should be understood that the present invention is not limited thereto. When the shift lever position detector 16 has a configuration that substantially detects a shift lever position, the shift lever position detector 16 may be within the scope of the present invention.

The tilt angle measuring device 100, controlled by the controller, may include hardware that may include at least one processor or microprocessor and electronic parts operating by a predetermined program, and the predetermined program may be formed with a series commands for executing a method of measuring a tilt angle according to an exemplary embodiment of the present invention to be described later. In other words, the tilt angle measuring device 100 may include a plurality of modules in which a program and hardware are combined.

Furthermore, as shown in FIG. 3, the tilt angle measuring device 100 that is formed with a plurality of modules in which a program and hardware are coupled may include a vehicle speed input unit 112 configured to receive an input of a signal of the vehicle speed sensor 12; an acceleration input unit 114 configured to receive an input of a signal of the acceleration sensor 14; a shift lever position input unit 116 configured to receive an input of a signal of the shift lever position detector 16; a wheel rotating direction detection unit 122 configured to detect a rotation direction of the wheel 22 of the vehicle; and a motor rotating direction detection unit 124 configured to detect a rotating direction of the motor 24 in an electric vehicle using power of the motor.

In an exemplary embodiment of the present invention, the vehicle may be an electric vehicle, and the electric vehicle may travel by power of only a motor or a hybrid vehicle that may travel by appropriately combining an internal combustion engine and power of a motor.

Further, the tilt angle measuring device 100, controlled by the controller, may include a vehicle reverse determination unit 150 configured to determine when the vehicle reverses based on a position of the shift lever, a rotating direction of the wheel 22, and a rotating direction of the motor 24; a vehicle speed value inversion unit 160 configured to invert a value of the detected vehicle speed to a negative number when the vehicle reverses; a traveling acceleration calculation unit 130 configured to calculate traveling acceleration based on the detected vehicle speed or a vehicle speed inverted to the negative number; and a tilt angle calculation unit 140 configured to calculate a tilt angle based on the calculated acceleration and acceleration detected by the acceleration sensor 14.

Each constituent element that is included in the tilt angle measuring device 100 may be formed in a module form in which a program and hardware are combined.

The vehicle speed input unit 112, the acceleration input unit 114, and the tilt angle calculation unit 140 may include a filter for removing noise included in a signal.

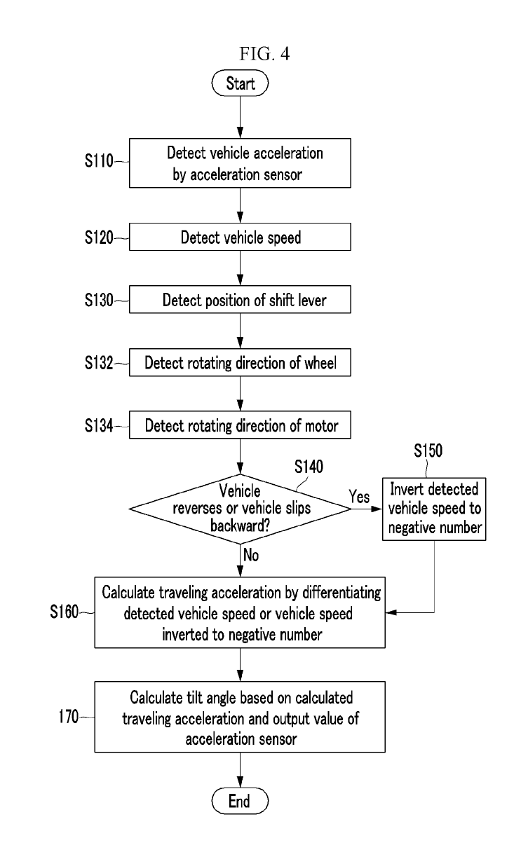

Hereinafter, a method of measuring a tilt angle according to an exemplary embodiment of the present invention will be described in detail with reference to the attached drawings. FIG. 4 is an exemplary flowchart illustrating a method of measuring a tilt angle, according to an exemplary embodiment of the present invention.

As shown in FIG. 4, the tilt angle measuring device 100, controlled by the controller, may receive an input of an acceleration signal that is detected by the acceleration sensor 14 through the acceleration input unit 114 (S110). In addition, the tilt angle measuring device 100 may receive an input of a vehicle speed that is detected by the vehicle speed sensor 12 through the vehicle speed input unit 112 (S120). The tilt angle measuring device 100 may also receive an input of a position of a shift lever that is detected by the shift lever position detector 16 through the shift lever position input unit 116 (S130). The vehicle speed input unit 112, the acceleration input unit 114, and the shift lever position input unit 116 may remove noise in the signal by filtering the input signal.

The tilt angle measuring device 100 may detect a rotating direction of the wheel 22 through the wheel rotating direction detection unit 122 (S132) and may detect a rotating direction of the motor 24 through the motor rotating direction detection unit 124 (S134). A detection of the rotating direction of the wheel 22 and the rotating direction of the motor 24 may be performed by a person of a common skill in the art through well-known technology and therefore a detailed description thereof will be omitted.

When a rotating direction of the wheel 22 and/or a rotating direction of the motor 24 is detected, the vehicle reverse determination unit 150 of the tilt angle measuring device 100 may determine whether the vehicle reverses or whether the vehicle slips backward (S140). When the vehicle reverse determination unit 150 determines that a position of the detected shift lever is a reverse position (R), the vehicle speed value inversion unit 160 of the tilt angle measuring device 100 may invert a value of the detected vehicle speed to the negative number (S150).

Further, when a position of the shift lever that is detected by the vehicle reverse determination unit 150 is a drive position D or a neutral position N, the vehicle reverse determination unit 150 may determine whether the vehicle slips backward based on the detected rotating direction of the wheel and/or the rotating direction of the motor (S140). When a position of the shift lever is a drive position D or a neutral position N and when a rotating direction of the wheel 22 rotates in a direction opposite to an advancing direction or when the motor 24 rotates in a direction opposite to an advancing rotation, the vehicle reverse determination unit 150 may determine that a corresponding vehicle slips backward.

When the motor 24 rotates in an direction opposite to a rotation direction when traveling, the motor rotating direction detection unit 124 may provide a rotation value of negative (−) and thus the vehicle reverse determination unit 150 may determine that a corresponding vehicle slips backward through a negative (−) rotation value. Additionally, when the wheel 22 rotates in a direction opposite to a rotation direction when traveling, the wheel rotating direction detection unit 122 may be formed to provide a negative (−) rotation value and the vehicle reverse determination unit 150 may determine that a corresponding vehicle slips backward through a negative (−) rotation value of the wheel 22. Thus, when a position of the shift lever is a traveling or is in a neutral position, when the vehicle reverse determination unit 150 determines that the vehicle slips backward, the vehicle speed value inversion unit 160 of the tilt angle measuring device 100 may invert a value of the detected vehicle speed to the negative number (S150).

Moreover, the traveling acceleration calculation unit 130 of the tilt angle measuring device 100 may calculate a traveling acceleration (a) based on a vehicle speed that is detected at step S120 or a vehicle speed that is inverted to the negative number at step S150. The traveling acceleration may be calculated by differentiating the detected vehicle speed or the vehicle speed that is inverted to the negative number by a predetermined time (S160).

When the traveling acceleration a is calculated, the tilt angle calculation unit 140 of the tilt angle measuring device 100 may calculate a tilt angle (θ) according to the following Equation 1, as described above, based on the traveling acceleration (a) and acceleration (long_accel_val) that is detected at step S110 (S170).

$$Ma = F - ( {F}_{areodynamic} + {F}_{Rolling} + {F}_{Climbing} ) \\ Ma = F - ( {F}_{areodynamic} + {F}_{Rolling} + Mg sin θ ) \\ F - ( {F}_{areodynamic} + {F}_{Rolling} ) = M \cdot ( a + g sin θ ) \\ long\_accel \_val = a + g sin θ \\ g sin θ = long\_accel \_val - a \\ sin θ ≅ θ = \frac{1}{g} ( long\_accel \_val - a ) \\ ∴ θ = \frac{1}{g} ( long\_accel \_val - a ) \qquad Equation 1$$

Wherein, M is a vehicle mass, a is a traveling acceleration of a vehicle, g is a gravity acceleration, F is an output of the vehicle, F_{aerodynamic} is air resistance of the vehicle, F_{rolling} is rolling resistance of the vehicle, and F_{climbing} is tilt resistance of the vehicle.

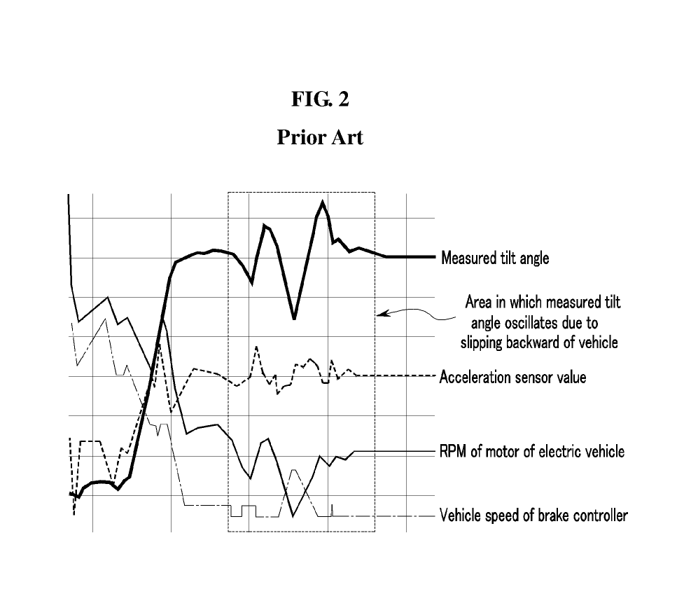

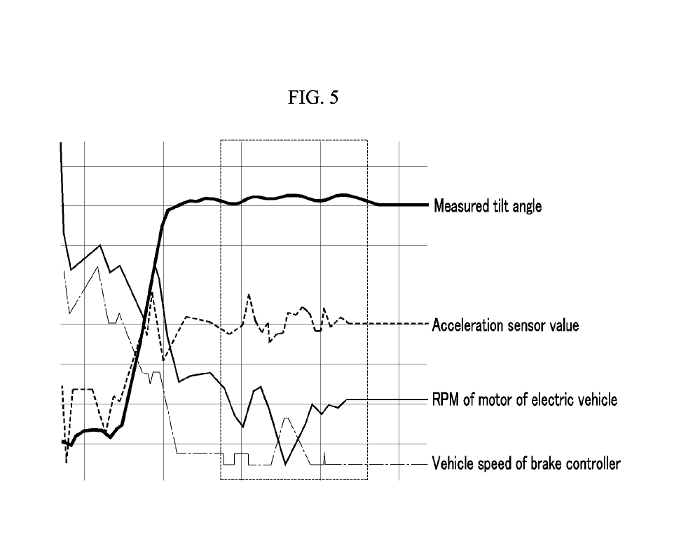

FIG. 5 is an exemplary tilt angle measuring graph, according to an exemplary embodiment of the present invention. Referring to FIG. 5, it may be seen that a measured tilt angle does not oscillate, as in shown FIG. 2 and maintains continuity of measuring the tilting angle. Thus, according to an exemplary embodiment of the present invention, when a vehicle reverses in a reverse gear (R) and when a vehicle slips backward in a drive gear (D) or a neutral gear (N), by inverting a speed value of the vehicle and by measuring a tilt angle, a continuously measured tilt angle when the vehicle moves forward may be maintained.

While this invention has been described in connection with what is presently considered to be exemplary embodiments, it is to be understood that the invention is not limited to the disclosed embodiments, but, on the contrary, is intended to cover various modifications and equivalent arrangements included within the spirit and scope of the accompanying claims.

What is claimed is:

1. A method of measuring a tilt angle of a traveling road, the method comprising:
detecting, by an acceleration sensor, an acceleration of a vehicle;
detecting, by a vehicle speed sensor, a vehicle speed;
detecting, by a shift lever position detector, a position of a shift lever;
detecting, by a controller, a rotation direction of a wheel;
detecting, by the controller, a rotation direction of a motor;
receiving, by the controller, an input signal of the vehicle speed sensor, the acceleration sensor, and the shift lever position detector;
inverting, by a controller, a value of the detected vehicle speed to a negative number based on the detected position of the shift lever, the rotation direction of the wheel, and the rotation direction of the motor;
calculating, by the controller, a traveling acceleration based on the detected vehicle speed or the vehicle speed inverted to the negative number; and
calculating, by the controller, the tilt angle of the traveling road based on the calculated traveling acceleration and the sensor acceleration.

2. The method of claim 1, further comprising inverting the value of the detected vehicle speed to the negative number, when the detected position of the shift lever is a reverse position.

3. The method of claim 1, further comprising inverting the value of the detected vehicle speed to the negative number, when the detected position of the shift lever is a driving position or a neutral position and when a wheel of the vehicle rotates in a direction opposite to an advancing direction.

4. The method of claim 1, wherein the vehicle is an electric vehicle traveling with power of the motor and further comprises inverting, by the controller, the value of the detected vehicle speed to the negative number, when the detected position of the shift lever is a driving position or a neutral position and when the motor rotates backward.

5. A system that measures a tilt angle of a traveling road, the system comprising:
a vehicle speed sensor configured to detect a vehicle speed;
an acceleration sensor configured to detect an acceleration of a vehicle;
a shift lever position detector configured to detect a shift lever position of the vehicle; and
a controller configured to:
detect a rotation direction of a wheel;
detect a rotation direction of a motor;
receive an input of a signal of the vehicle speed sensor, the acceleration sensor, and the shift lever position detector;
invert a value of the detected vehicle speed to a negative number based on the detected position of the shift lever, the rotation direction of the wheel, and the rotation direction of the motor;
calculate a traveling acceleration based on the detected vehicle speed or the vehicle speed inverted to the negative number; and
calculate the tilt angle of the traveling road based on the calculated traveling acceleration and the sensor acceleration .

6. The system of claim 5, wherein the controller is further configured to invert the value of the detected vehicle speed to the negative number in response to detecting a reverse position of the shift lever.

7. The system of claim 5, wherein the controller is further configured to invert the value of the detected vehicle speed to the negative number in response to detecting a driving position or a neutral position of the shift lever and in response to detecting a wheel rotation in a direction opposite to an advancing direction.

8. The system of claim 5, wherein the controller is further configured to invert the value of the detected vehicle speed to the negative number in response to detecting a driving position or a neutral position of the shift lever and in response to detecting a backward rotation of the motor.

9. A non-transitory computer readable medium containing program instructions executed by a processor or controller, the computer readable medium comprising:
program instructions that control a vehicle speed sensor to detect a vehicle speed;
program instructions that control an acceleration sensor to detect an acceleration of a vehicle;
program instructions that control a shift lever position detector to detect a shift lever position of the vehicle;
program instructions that detect a rotation direction of a wheel;
program instructions that detect a rotation direction of a motor; and
program instructions that receive an input of a signal of the vehicle speed sensor, the acceleration sensor, and the shift lever position detector;
program instructions that invert a value of the detected vehicle speed to a negative number based on the detected position of the shift lever, the rotation direction of the wheel, and the rotation direction of the motor;
program instructions that calculate a traveling acceleration based on the detected vehicle speed or the vehicle speed inverted to the negative number; and
program instructions that calculate the tilt angle of the traveling road based on the calculated traveling acceleration and the sensor acceleration .

10. The computer readable medium of claim 9, further comprising:
program instructions that invert the value of the detected vehicle speed to the negative number in response to detecting a reverse position of the shift lever.

11. The computer readable medium of claim 9, further comprising:
program instructions that invert the value of the detected vehicle speed to the negative number in response to detecting a driving position or a neutral position of the shift lever and in response to detecting a wheel rotation in a direction opposite to an advancing direction.

12. The computer readable medium of claim 9, further comprising:
program instructions that invert the value of the detected vehicle speed to the negative number in response to detecting a driving position or a neutral position of the shift lever and in response to detecting a backward rotation of the motor.
